(19) United States
(12) Patent Application Publication
(10) Pub. No.: US 2007/0170000 A1
(43) Pub. Date: Jul. 26, 2007

(54) System for a promotional showroom

(76) Inventor: Tamara Molde, Hastings, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/518,861

(22) Filed: Sep. 11, 2006

Related U.S. Application Data
(60) Provisional application No. 60/715,694, filed on Sep. 9, 2005.

(51) Int. Cl. B65G 47/00; E04H 3/00

(52) U.S. Cl. 186/35

(57) ABSTRACT

A membership promotional goods showroom, where manufacturers, suppliers and other providers of promotional goods and distributors of promotional goods can be members, for a fee. Membership can be selected for one, a few, or all promotional goods showroom locations.

### CROSS-REFERENCE TO RELATED APPLICATIONS

This application claims priority to U.S. Provisional Patent Application Number 60/715,694, filed Sep. 9, 2005, entitled “SYSTEM FOR A PROMOTIONAL SHOWROOM,” which is incorporated herein by reference.

### FIELD OF THE INVENTION

The present invention relates to providing a promotional showroom for the use of suppliers, manufacturer, distributors and buyers. More particularly, the present invention relates to a system whereby manufacturers of promotional items, such as mugs, pens, shirts and other clothing items, can display their goods and where distributors can view the goods as well as bring their clients to the promotional showroom to view the various manufacturers' goods. The promotional showroom is particularly well-adapted to provide “one-stop shopping” for promotional items for distributors and their clients.

### BACKGROUND OF THE INVENTION

Various businesses and organizations utilize promotional items such as pens, pencils, golf balls, mugs, letter openers, shirts and other types of clothing, to promote their business, organization, product line, special event and the like. These promotional items are customized to the needs of the particular purchaser. Oftentimes, these types of promotional items can be found in catalogs. The buyer can review the offerings in the catalog and determine which items to purchase and place an order.

However, ordering promotional items in this manner often limits the message on the item to simple text and possibly a simple graphic. Further, the quality of the promotional item is difficult to determine from the pages of a catalog. For example, there is a wide range of quality available with respect to clothing, for example, to polo-type shirts. Although the fabric content can be provided in a catalog or via telephone, the weight of the fabric and the “feel” of the fabric are more accurately determined if the shirt can be held and felt.

Further, suppliers and manufacturers must find ways to advertise their promotional goods to various businesses and organizations through distributors. Oftentimes this means compiling mailing lists and sending out advertisements and product catalogs. Manufacturers use distributors to assist in these sales and marketing efforts. Nevertheless, it can be difficult to reach the potential purchasers of the manufacturer's goods and this invention would allow their products to be on display for distributors to show their clients.

In addition, the potential purchasers of the manufacturers' goods may not be aware of the various manufacturers and their goods or know how to contact the various manufacturers to obtain information about the promotional items that may be available. Further, one manufacturer may not offer all of the goods that a purchaser may require.

Hence, a purchaser may need to contact a number of manufacturers/distributors to obtain all of the promotional items required. However, the purchaser may still be able to rely only on an oral or written description of the goods, or perhaps additionally, a picture of the goods. If reasonably convenient, the purchaser would more than likely appreciate being able to see and touch the promotional items prior to purchasing the items.

Further, a distributor may represent a number of manufacturers who each make different promotional items. Therefore, the distributor may need to keep a stock of all the manufacturers' catalogs and promotional materials to give to potential purchasers/clients. Additionally, the distributor may also have samples of some, typically but not all, of the manufacturers' promotional items. These must be either stored somewhere for retrieval as needed or be mobile and accompany the distributor on sales calls or client visits.

There is a need to provide a more streamlined method of providing promotional items to distributors to show clients, such that the purchaser/client can see and touch the promotional item prior to purchasing the item(s).

### SUMMARY OF THE INVENTION

The present invention relates to a membership promotional goods showroom, where both manufacturers of promotional goods and distributors of promotional goods can be members, for a fee. Membership can be selected for one, a few, or all promotional goods showroom locations.

Member-manufacturers and member-suppliers, as well as others can display their promotional products in a designated space in the promotional goods showroom and offer promotional goods catalogs, which can be obtained at the promotional goods showroom. Member-distributors can bring clients/potential purchasers of promotional goods to the promotional goods showroom to view the goods and to potentially place orders for the goods with the manufacturers; members.

The promotional goods showroom also offers a variety of services such as a catalog room, sample ordering services, artwork services, fulfillment services, meeting rooms, seminar rooms, sales offices, photocopying, telephone messaging, a research room and the like.

The invention is also directed toward a method of facilitating sale of promotional items, where the method comprises the steps of enrolling two or members, obtaining from at least one member one or more promotional items, displaying the one or more promotional items in a secure showroom, and allowing access to the secure showroom to one or more distributors, wherein the one or more distributors have paid a fee for access to the secure showroom. The one or more members may manufacturers of items that may be used as promotional items and suppliers of promotional items. In addition, one or more of the members may have paid a fee for the display of the one or more promotional items in the secure showroom.

### DETAILED DESCRIPTION OF THE INVENTION

The promotional showroom is a membership based location for factories to display their products and offerings every day of the month. Distributor (Sales Executives or Advertising Specialists but not limited to) may have an organized updated showroom to view products, gather ideas for their clients, invite their clients to the showroom and use it as often as they would like depending upon what membership package they purchased. The promotional showroom may be opened almost every day of the year, so the cost will be nominal for the increase in business that this concept can help you to make if that is your goal. The promotional showroom may open offices nationwide so that when the Distributor pays a monthly fee, they can have the option to join on a local level or national level.

The members can join to use the local market promotional showroom in a particular state or pay for an upgraded membership, to access all of the showrooms opening across the United States, which will enable them to be as large as they would like to be. Discounts may be given to members who pay in advance for longer term memberships. There will be an Application fee and monthly fee or pay-per-visit/daily pass.

The promotional showroom may run promotions at the beginning to offer the first 30 days free. Distributors with multiple sales people will receive a discount for their Sales Executives or staff wanting to join Promo Showrooms. Members may join under a personal identification number, not the distributor as a whole; memberships may be sold only to individuals.

The promotional showroom may offer three tier memberships to factory members; bronze, silver, gold and plan to base it on the number of products they would like on display. The promotional showroom may offer discounted or free catalog insertion into the filing system located in a catalog research room. The products that the factory members will choose to have on display may be listed on a web site as well with virtual sample technology.

The promotional showroom may also offer members storage space to stock their most popular items in a warehouse and in turn save them time and money shipping to all of the separate Distributor locations and Sales Executives. The promotional showroom may encourage the factories to host their meetings in the showroom facility when in from out of town. For example, in Minnesota alone, there are over 691 distributor offices and within those several Sales Executives and Advertising Specialists whom may be targeted.

The showroom space available to supplier members may be offered on a first come first serve basis to create urgency to encourage the suppliers to join to place their most popular products in the showrooms first. There are several suppliers who import the same product or very similar; there may be restrictions on duplicates per showroom. In this situation, once a factory selects the 40-50 items they plan to put on display, a competitor is unable to offer the same products at the promotional showroom. However, if that factory misses out on one location and there is another location available to display the item, they have first choice if the other factory chose not to be in that location.

The samples may be provided by the factories at no charge to the promotional showroom, catalogs may be requested to be placed in the Research room at no charge, storage space in the warehouse is available for overstock as needed and if available. Samples will not be accepted unless confirmation from Promo Showroom accepting receipt is received.

Product Submission and Approval Process

The promotional showroom may encourage factories to use the promotional showroom as their local site or additional partner to reach all of the Distributors to pick up a free sample. The promotional showroom may have to charge for that space and storage, depending on availability. For the promotional showroom display samples, the promotional showroom may re-code the sample item number and also list on the sample, the colors that it's available in along with pricing of the item from the minimum price point to the highest. All samples may be placed in secure custom designed displays so they are “On Display 24/7” and will get exposure almost 365 days of the year.

The promotional showroom may also offer memberships and advertising space to any other industry other than ASI and PPAI members as long as the members and their clients can benefit from these memberships or members. The promotional showroom promotional showroom could become a marketing showroom and resource center known nationwide in the market place for the top marketing professionals and presidents wanting to grow their businesses and discover the newest and most innovative ways to achieve their marketing goals.

The promotional showroom may sell advertising space within areas of the promotional showroom. Some examples might be behind a front desk, on video monitors displayed throughout the space, in a conference room, on a featured “new” ideas wall when members, distributors, clients or others first enter the showroom.

The Promo Showroom Experience

When a member arrives with or without a guest, they may be greeted by a front desk manager who may check them in. It should also be understood that in some embodiments, distributors are not considered “member” for purposes of the present invention. However, distributors will have access to the showroom by payment of a fee as mentioned hereinabove. The members may eventually have a membership card like a gym membership concept to check in. The members swipe their card when entering, answer a few questions by pressing the screen when prompted, otherwise the members may not be able to pass the sensor wall. The promotional showroom entry system may have a series of questions they may answer at every visit to enable us to track “why” they are here? Some examples are: the number of guests they are bringing with them, to use the research area, conference room, kitchen to host a reception in the showroom, using offices in between appointments, educational seminar, graphic designer library, pick up samples, etc. Such a system would enable the promotional showroom to track the areas and benefits to discontinue or expand on in each market.

There may be a monitor displayed of specials, new innovative ideas etc. . . . that may be viewed by all incoming clients and members. The promotional showroom may have these monitors in several comers of the promotional showroom.

There may be a promotional showroom manager on staff at every location to familiarize members with the space and all of our services when you arrive if desired. The new members may receive a “welcome packet” upon joining and will receive all of the member benefits that will be constantly changing that the promotional showroom has to offer. The promotional showroom manager may give members a tour at the beginning and walk members and/or guest(s) through the space initially.

When a distributor sales executive invites in an end user to the promotional showroom, they will receive a packet describing the services and layout of the showroom. The packet may include coded item numbers, location of that item and price point of that item from the minimum quantity to the maximum quantity price and color options as well as set up charges for imprinting.

The distributor may receive a different packet with additional information added from the end user packet. Their packets will list the factories on display in the showroom, ASI number, the factory item number and coded pricing, colors available in and set up charges.

The promotional showroom may be light and airy, custom display cases with advertising specialties on display in secure cabinets so that the items will remain in the same place from day to do unless discontinued or replaced by suppliers with another item. The promotional showroom may encourage our factories to keep the promotional showroom up to date when the factories discontinue an item so that the promotional showroom may pull such items from the showroom floor immediately. The displays may be of glass, glass shelves and a birch wood with silver trim. The promotional showroom may have all clothing samples chained together to keep them in an order as well so that they again remain in the same place for show only. All samples can be ordered from the factory and will be sent to the location of choice.

The promotional showroom kitchen may be very functional and set up for throwing mini receptions for clients to see products on display. The kitchen may have a microwave and refrigerator, so that there is opportunity to host receptions at the promotional showroom for end users to see all of the items on display. The promotional showroom plans to work with local restaurants and caterers to provide catering service when needed for open houses, receptions, meetings and presentations at the promotional showroom.

For the distributor members, the promotional showroom may offer office space with furniture such as tables and chairs for client meetings, bookcases with the tools that distributors need and DSL or cable. Intended use is to check their e-mails, return phone calls, work on quotes, follow up or whatever they would do at their office if it's not close to their next meeting. The promotional showroom may also encourage client meetings in its offices and to use it as their satellite office if they wish. The members may be given a specified amount of free hours per month and after that, there may be a charge. The promotional showroom may be giving all members a passcode to use for long distance calls that will be billed directly to their phone account and credit card on file with the promotional showroom.

The promotional showroom may offer a research room which will have computers and research tools like ESP and SAGE. There may be current factory catalogs from all members and nonmembers as it is our research room. The graphic designer portfolios may be on display in this room. The promotional showroom educational library and trade magazines will be featured in this room to help you be as educated as members would like to be in the Advertising and Marketing Industry. The copy machines may have a sensor on them so in order to use them. The distributor will have to check out the sensor key and return it to the front desk before leaving and pay for their copies made. The promotional showroom may have meeting rooms with small tables that will fit up to four (4) people to brainstorm and work on project presentations.

The promotional showroom may offer a conference room to be reserved for client meetings for distributor to hold brainstorming meetings or sales meetings with their clients. The conference table may hold 8-12 people around it and will include conference call capabilities. The promotional showroom may include a state-of-the-art rear screen projection so that if there are client meetings in this room, the presentations for catalog or fulfillment programs will be displayed on a large screen projection. The promotional showroom may also have displays in this room that will be sold to the factories as we feel that this room will become booked for the top executives in the area for marketing planning meetings.

The promotional showroom may be open almost every day of the year so our members will be able to work on large projects over the weekends and after work hours if they need to get things done for a client meeting. Distributor members may be able to check out or buy samples of our overstock and if not returned within the time allowed (7-10 days) they will be billed for the sample plus shipping charges. All clothing samples may be chained together so they stay in the same place and have sensors on them so that they will not be able to leave the promotional showroom as that is what we are offering. The major benefit of this showroom is that samples are now on display 24/7 for members and clients to see and show your clients and eventually for your clients to view the products on their own.

How our Showroom Works

All items may be tracked and organized in our proprietary software to locate them instantly. Software may be designed to keep the promotional showroom organized and may include all factory members, contact, address, phone, fax, images of all items on display, item numbers, our coded item numbers, location of the item, list prices and net prices, set up charges etc.

If the promotional showroom allows end users to enter our showroom and/or are sent to visit the promotional showroom by their distributor to view products, they will not be sold to. The promotional showroom will not be able to allow them upstairs into the offices, conference rooms, research or catalog rooms and can not be responsible if other distributor members using the showroom space approaches your clients while you are not present. It is a good idea to be present with all clients entering the showroom. Soliciting business while at the promotional showroom is not encouraged and membership may be canceled immediately. If there are “walk in” end users who enter the showroom and want to look around, they do not have a sales executive that they are loyal to, they will be given a print out of all distributor members within their zip code or the zip code of choice. Therefore, this will provide business leads to our distributor members.

All showroom clothing samples may have sensors as they are not to be removed from the promotional showroom. The promotional showroom intends to have samples in its warehouse space so that they are available to be purchased if a distributor member or their client wants to take items with them. It may operate similar to a shoe department. You see the shoe that you want to try on and we bring it out for you to view or purchase. The main benefit to the promotional showroom concept is that the samples never leave; they are always on display 24/7 for distributor members and corporate buyers to see and plan for future marketing opportunities. The promotional showroom offers a trade show of products on display for almost 365 days of the year of current updated products! Visit the promotional showroom daily to see the “new” items, which will be marked “new” for each quarter. Also a master catalog from every factory in the research room will have a sensor on them similar to library books so that they are unable to be removed from the promotion showroom. This again will guarantee that the catalog members and visitors are looking for is always available.

Additional Services

Large meeting rooms to host seminars to earn CAS and MAS credits in the industry, brainstorming sessions for distributor members only, quoting services division, graphic designer services division and fulfillment division. The promotional showroom may also offer office suites to sales people working out of their homes or working for distributors outside of the state that they reside so that they are able to have an office, showroom for viewing products, and a receptionist to answer phone calls if needed and wanted. If there is sufficient demand, the promotional showroom may offer recruiting services, as the promotional showroom will have contacts throughout the entire industry in its membership base and services.

The conference and meetings rooms to host educational classes for the distributor to work on their MAS and CAS certifications. The promotional showroom may be the site to host marketing seminars for end users, invite local and national speakers and marketing professionals to present. The promotional showroom may also host seminars for the distributor members, which will focus on ways they can gain knowledge of the factory member's product lines available to them as well as ways to solve the 17 marketing problems that will be posted. The promotional showroom may eventually offer marketing seminars for the end users and charge a fee.

Brainstorming sessions for distributor members only will help and assist them to solve the marketing challenges within their client's organizations. This will allow the corporations the brainpower of our members to be given ideas developed from new and seasoned distributor members.

Quoting services may be provided if desired by our members, which will be an additional charge and billed per quote completed or requested. The distributors will have the option to fill out the form posted on our website to be e-mailed, or be able to print out the .pdf file to fill out by hand and faxed in to the quoting division.

The promotional showroom may offer 5 layouts or templates available to the distributor for their quotes available so they will have some customization to not look like their competition.

When the distributor goes online or fills out the quoting request form, they will enter the ASI number or the factory(ies) they are wanting a quote from, line name, quantities that they are wanting pricing on and the margin that they would like to be at, unless they just want us to enter the list pricing from the catalog.

The distributor will be able to select up to 5 formats to choose from so they can differently than their competition if they are also taking advantage of the service. The promotional showroom will then type up the quote within 24 hours unless rush service is desired and send the formalized quote to the distributor for them to personalize with their customer information so they can forward to their customer. The distributor can change pricing to their desired mark up, edit the quote to their specs and mark up or else the promotional showroom can design the quote entirely for them to forward on.

The promotional showroom is not in competition with the distributors, nor their sales executives or advertising specialists and will or can sign non-compete agreements with the distributor members or it may be a part of our membership application terms and conditions.

Graphic designer services may be offered if the distributors feel they want to pay for their services and the convenience of having graphic designers on site to meet with their needs. The designers will then be face to face, accessible for brainstorming sessions to help sell marketing concepts to their clients.

The promotional showroom may also offer a resource area of designer's work and portfolios submitted by them and paid for by them to be utilized by the companies as well as the distributor sales people. The promotional showroom may have the graphic designer submit a template or cover form sheet outlining the work they have done, or enjoy doing in areas in which they have talents. They may submit their work and style all in the same format as every other designer and their binder will be placed in the research area similar to the dating service concept of profiles. These books will display their work so that the distributors can view their style and decide what designer they would like to work with for their clients, depending upon their clients' needs.

The designers may also be posted on the promotional showroom web site to make them accessible to the other offices within the USA. Designers will be recruited and encouraged to use our services. They will pay a membership fee for marketing their work. The promotional showroom will post the work that they enjoy and have experience in. The graphic designers will be categorized by experience, length in field and price to allow corporations to select the designer that they are trying to fit their current needs.

The promotional showroom may show a sampling of the graphic designers work and then offer how to get in touch with them. The promotional showroom will not guarantee that they get work as it depends upon their work and the needs of our clients and theirs and of course what the graphic designers bring to the table. This service will be an additional benefit that can be paid for on a monthly service by distributors and corporations. It can work as a job recruiting and placement service for the graphic designers. Once they are discovered, companies may offer them a job or the graphic designer can choose, to be an independent or start their own agency depending on their demand.

Fulfillment services may be offered to our distributor members and the promotional showroom may contract this service out to reputable companies per market as a needed basis. They will help to facilitate catalog programs and again, the promotional showroom is not selling any items, but offering a service and the resources that the distributor sales executives and factories might be able to utilize. The promotional showroom is working to partner companies together to be successful and offer the services that are approved through the promotional showroom and their distributor members to be the best in their industry and work as a huge team.

Office suites may be available for distributor members to rent on a monthly basis if they would like an office centrally located and in a city location. All suites may have access to the promotional showroom and there may be a receptionist provided who will answer phones and transfer them accordingly. There will only be distributor members able to rent the office space on availability. They will sign a year lease for this commercial space, desks, credenzas, filing cabinets and bookshelves will be provided.

Since the promotional showroom is in contact with the distributors and factories, the promotional showroom may offer recruiting services to our distributor members. This will be an additional charge as the price paid for the talent will be determined by the position we are filling. The promotional showroom intends to be the preferred recruiting choice for our selection process and expertise in this field. Post the positions you are looking for, where and the promotional showroom will do the rest!

Marketing of the Promotional Showroom

The promotional showroom may send out press releases to all major media relations managers for publicity and to educate the local markets of our new business concept and model.

The promotional showroom may work with ASI, PPAI, trade magazines among all others to partner with all to become their “Your Organized/Current/Updated Source of Ideas.” The promotional showroom ads and articles may display the showroom and encourage distributor sales executives and advertising specialist to register on the website and enter their zip code if they would like a promotional showroom in their area. The promotional showroom then will expand in all major markets in the United States depending upon the demand.

It is contemplated that features disclosed in this application, as well as those described in the above applications incorporated by reference, can be mixed and matched to suit particular circumstances. Various other modifications and changes will be apparent to those of ordinary skill.

What is claimed:

1. A method of facilitating sale of promotional items, the method comprising the steps of:
enrolling two or members;
obtaining from at least one member one or more promotional items;
displaying the one or more promotional items in a secure showroom; and
allowing access to the secure showroom to one or more distributors, wherein the one or more distributors have paid a fee for access to the secure showroom.

2. The method of claim 1, wherein the one or more members are selected from the group consisting of manufacturers and suppliers.

3. The method of claim 1, wherein the one or more members have paid a fee for the display of the one or more promotional items in the secure showroom.
